(19) United States
(12) Patent Application Publication
(10) Pub. No.: US 2022/0325573 A1
(43) Pub. Date: Oct. 13, 2022

(54) INSULATING GLAZING WITH LOW-POWER HEATING AND HIGH MECHANICAL STRENGTH

(71) Applicant: SAINT-GOBAIN GLASS FRANCE, COURBEVOIE (FR)

(72) Inventor: Thomas TONDU, SAINT-MARTIN D'ABBAT (FR)

(21) Appl. No.: 17/638,652

(22) PCT Filed: Aug. 4, 2020
(86) PCT No.: PCT/EP2020/071864

§ 371 Date: Feb. 25, 2022

(30) Foreign Application Priority Data
Aug. 30, 2019 (FR) 1909538

(51) Int. Cl. E06B 3/67; E06B 3/66; E06B 3/663

(52) U.S. Cl. CPC E06B 3/6715; E06B 3/6612; E06B 3/66309; B64C 1/1484

(57) ABSTRACT

An insulated glazing unit includes a first laminated pane including two glass sheets, each no more than 2 mm thick, that are bonded to one another by an intermediate adhesive layer, a second structural laminated pane providing the mechanical strength required for the flight conditions of an airplane, in particular resistance to bird strike and control of glazing unit deformation under pressure difference conditions during a flight on either side of the insulated glazing unit, and a gas gap between the first and second laminated panes, the first laminated pane being provided with a heating system.

The present invention relates to the field of glazing, and more specifically to a heated insulated glazing unit with low heating power and high mechanical strength.

Aeronautical cockpits are conventionally fitted with two central glazing units and four or six lateral side glazing units. All of these glazing units are potentially liable to fogging arid icing problems that require heating.

For aerodynamic reasons, the external faces of the front glazing units are exposed to ice, which requires high power and de facto prevents the risk of mist (or ice) forming on tho internal faces of those glazing units.

Conversely, since the external faces of the lateral glazing units are not usually exposed to ice, said glazing units are not provided with heating to prevent, icing. Consequently, a dedicated heating system for handling fogging (or icing) on the internal wall of the glazing unit (cockpit side) has to be provided. In addition to handling fogging (and potentially icing) on the internal face of the glazing unit (good visibility), this heating provides significant comfort to the pilot by eliminating/limiting the cold-wall sensation.

The lateral glazing units in aeronautical cockpits are made of laminated organic or mineral glass. These panes are made of two or three plies and are therefore heated. The term “ply” is commonly understood to mean a sheet of mineral glass or of organic glass (transparent polymer material) forming a pane, excluding the intermediate adhesive layers bonding the plies together in pairs.

There are also exceptionally plastic panes (organic polymer materials) with. no heating system due to the use of double glazing. This is made possible through the use of plastics that provide good thermal insulation compared to glass panes.

Finally, blown not air also helps t.o prevent fogging.

Paradoxically, the heating power (used to prevent fogging) dissipated in the laminated panes is discharged outside the airplane, although the heating is intended to heat the internal skin of the laminate. This is caused by the extreme cold (typically −50° C.) and the high convection associated with the flow speed of the external air. This requires the application of specific powers of 1500 to 2000 Wm². Consequently, when in flight, the internal wall is cold (about 0° C.) and creates an uncomfortable environment for the pilots. This cold-wall effect is even more marked if the cockpit is smaller, where the panes are very close to the pilots, who may feel that the panes are too hot on the ground and too cold in flight.

These high powers require the use either of heating system. based on thin wires, which are unreliable (fatigue breakage), unsightly and visually obstructive (heat haze, diffraction), or power supply voltages enabling heating using conductive layers (higher quality than wires). To deliver specific powers in the order of 1500 W/m² to these layers, access to a high power supply voltage is required. This is a major constraint, in particular in small airplanes, which use voltages of 28 V for example.

The few plastic glazing units forming double glazing to obviate the need for heating result in glazing units of increased thickness and mass, since the absence of lamination mechanically dissociates the plies, which. very significantly reduces mechanical performance (bird strikes and pressure).

Furthermore, the performance of double glazing is significantly increased by using a reflective infrared layer, which is difficult to achieve with plastic without significantly reducing light transmission. Silver Ag or Au layers can be applied to plastic relatively easily without degrading the optical transparency quality of the substrate, but a layer of tin-doped indium oxide (ITO) cannot, for example. Finally, the complex shapes of the glazing units require layer deposits of different thicknesses, which in the case of gold or silver results in non-homogeneous appearance and light transmission qualities.

Furthermore, the lateral heating elements are incorporated on the thickest, structural plies, which ensure pilot safety. An electrical failure could result in one or two structural plies breaking, which would put the flight in danger. For this reason, it is common practice to heat the outward-facing face of the external structural ply to avoid positioning the heating system between two structural plies. The heating function of the internal face of the glazing unit is thus removed relatively far away from this internal face, which has an adverse effect on heating power.

This invention is intended to avoid all of these drawbacks, and is in particular intended to considerably reduce the power dissipated in the lateral glazing units, while maintaining a higher internal-wall temperature and the mechanical strength necessary for the specific usage conditions of a flight.

For this purpose, the invention relates to an insulated glazing unit comprising a first laminated pane comprising two glass sheets, each no more than 2 mm thick, that are bonded to one another by an intermediate adhesive layer, a second structural laminated pane providing the mechanical strength required for the flight conditions (airplane, etc.), in particular resistance to bird strike and control of pane deformation under pressure difference conditions during a flight on either side of the insulated glazing unit, and a gas gap between the first and second laminated panes, the first laminated pane being provided with a heating system.

The thin portion (first laminated pane) is provided with a heating system designed to keep the inner wall of the insulated glazing unit at a temperature close to 20° C. with very low heating power compared to the heating power usually applied to lateral glazing units.

This assembly entirely dissociates the portion of the glazing unit that has a mechanical function (thick portion: second structural laminated pane) from the portion that has a thermal function (first laminated pane.), thereby reducing the risk of mechanical failure.

The gas in the gas gap can be air, a noble gas such as neon, argon, krypton, etc.

The heating system is advantageously supported by the surface of the first laminated pane delimiting a partial surface of the gas gap.

Preferably, the first and second laminated panes are held together by a spacer, in particular a frame-shaped spacer, such as to form the gas gap between the first and second laminated panes.

Preferably, the second structural laminated pane has at least one glass sheet at least 4 mm thick, laminated on either side to a glass sheet by means of an intermediate adhesive layer.

Preferably, each of the two glass sheets forming the first laminated pane is at least 1.5 mm thick, and preferably 1 mm thick, and particularly preferably 0.8 mm thick.

Preferably, the heating system is a tin-doped indium oxide (ITO) electrically conductive layer.

Preferably, the glass sheets forming the insulated glazing unit are made of soda-lime, aluminosilicate or borosilicate glass, optionally tempered thermally or chemically (also referred to as chemical toughening), or of a transparent polymer material such as poly (methyl methacrylate) (PMMA), polycarbonate (PC), polyurethane or polyurea (PU).

Preferably, the intermediate adhesive layers forming the insulated glazing unit are made of polyvinyl butyral (PVB), thermoplastic polyurethane (TPU), ethylene-vinyl acetate (EVA), optionally multilayer such as to provide sound damping.

The flexibility of the first laminated pane, which is quite thin, enables said pane to be deformed to accommodate the variations in pressure, such that the pressure outside the insulated glazing unit on the side of the first laminated pane (thin) is equal to the pressure of the gas gap (isobar). However, the air gap is preferably hermetically and sealingly separated from the volume outside the insulated glazing unit on the side of the first laminated pane by a flexible inflatable membrane. This inflatable vent means that there is no gas exchange between the atmosphere outside the insulating glazing unit on the side of the first laminated pane and the gas gap, and no moisture condensation on the surface of the second structural laminated pane delimiting a partial surface of the gas gap.

The invention also relates to the use of an insulated glazing unit as described above as an aircraft glazing unit, the first laminated pane being oriented towards the internal volume of the aircraft and the second laminated pane being oriented towards the outside atmosphere. The invention in particular relates to such an application as the lateral glazing unit of an airplane cockpit.

A specific embodiment is described below with reference to the attached drawing to better illustrate the subject matter of the present invention.

In this drawing:

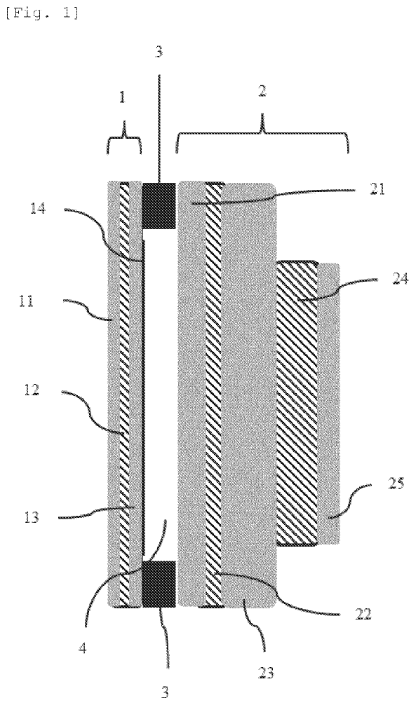

FIG. 1 shows a schematic cross-section view of an insulated glazing unit according to the present invention.

FIG. 1 shows an insulated glazing unit according to one embodiment of the invention.

The insulated glazing unit is formed by assembling a first laminated pane 1 and a second structural laminated pane 2, separated by a cavity 4 that is 2 mm thick and that contains air.

The first laminated pane 1 is made of two monolithic glass sheets 11, 13 that are 0.5 mm thick and that are separated by an intermediate adhesive layer 12 that is 0.38 mm thick.

The free surface of the glass sheet 13 facing the second structural laminated pane 2 bears a conductive layer made of five-ohms-per-square tin-doped indium oxide (ITO) to provide low-emissivity infrared-radiation reflection and heating functions.

From the air gap 4 towards the free surface of the insulated glazing unit, the second structural laminated pane 2 is made up of a glass sheet 21 that is 3 mm thick bonded to a glass sheet 23 that is 8 mm thick by an intermediate adhesive layer 22 that is 2 mm thick, and a glass sheet 25 that is 3 mm thick bonded to the glass sheet 23 by an intermediate adhesive layer 24 that is 3 mm thick.

The first and second laminated panes 1, 2 are held together with a 2 mm space such as to form the air gap 4 using a spacer frame 3.

All of the glass sheets are chemically or thermally tempered aluminosilicate or soda-lime glass sheets. The intermediate adhesive layers are thermoplastic polyurethane (TPU) or polyvinyl butyral (PVB) layers, possibly multilayer such as to provide sound damping.

The height and width of the insulated glazing unit is in the order of 60 cm.

Where the insulated glazing unit is assembled as a lateral glazing unit of an airplane cockpit, the first laminated pane 1 is oriented towards the cockpit and the second laminated pane 2 is in contact with the outside atmosphere.

In the following conditions: internal convection of 7 W/m²/° C. and air at 20° C. external convection of 110 W/m²/° C. and air −50° C., the proposed solution enables an internal skin temperature (free surface of the glass sheet 11=internal face of the insulated glazing unit) of 11° C. to be maintained with a power of 500 W/m², while 2300 W is required in the absence of (insulated) double glazing with heating on the outer face of the middle Glass in conventional laminated panes (i.e. the second glass sheet from the outside).

The lower power is compatible with a 28 V power supply (standard).

The low power can obviate the need for control sensors (cause of failure).

This system improves the reparability of the heating portion of the glazing unit.

The mechanical plies are also protected from scratching that could cause the glazing unit to break.

By reflecting infrared radiation, the low-emission function of the ITO heating layer 14 keeps the heat inside the airplane.

1. An insulated glazing unit comprising a first laminated pane comprising two glass sheets, each no more than 2 mm thick, that are bonded to one another by an intermediate adhesive layer, a second structural laminated pane providing mechanical strength required for flight conditions, including a resistance to bird strike and control of glazing unit deformation under pressure difference conditions during a flight on either side of the insulated glazing unit, and a gas gap between the first laminated pane and the second structural laminated panes, the first laminated pane being provided with a heating system.

2. The insulated glazing unit as claimed in claim 1, wherein the first laminated pane and the second structural laminated pane are held together by a spacer to form the gas gap between the first laminated pane and the second structural laminated panes.

3. The insulated glazing unit as claimed in claim 1, wherein the second structural laminated pane has at least one glass sheet at least 4 mm thick, laminated on either side to a first glass sheet by means of an intermediate adhesive layer and to a second glass sheet by means of an intermediate adhesive layer.

4. The insulated glazing unit as claimed in claim 1, wherein each of the two glass sheets forming the first laminated pane is at most 1.5 mm thick.

5. The insulated glazing unit as claimed in claim 1, wherein the heating system is a tin-doped indium oxide electrically conductive layer.

6. The insulated glazing unit as claimed in claim 1, wherein the glass sheets forming said glazing unit are made of soda-lime, aluminosilicate or borosilicate glass, optionally tempered thermally or chemically, or of a transparent polymer material.

7. The insulated glazing unit as claimed in claim 1, wherein each intermediate adhesive layers of said glazing unit is made of polyvinyl butyral (PVB), thermoplastic polyurethane (TPU), or ethylene-vinyl acetate (EVA), optionally multilayer to provide sound damping.

8. The insulated glazing unit as claimed in claim 1, wherein the air gap is hermetically and sealingly separated from a volume outside the insulated glazing unit on the side of the first laminated pane by a flexible inflatable membrane.

9. A method comprising manufacturing an aircraft glazing unit with the insulated glazing unit as claimed in claim 1, the first laminated pane being oriented towards an internal volume of the aircraft and the second structural laminated pane being oriented towards an outside atmosphere.

10. The method as claimed in claim 9, wherein the aircraft glazing unit is an airplane cockpit lateral glazing unit.

11. The insulated glazing unit as claimed in claim 2, wherein the spacer is a frame-shaped spacer.

12. The insulated glazing unit as claimed in claim 4, wherein each of the two glass sheets forming the first laminated pane is at most 1 mm thick.

13. The insulated glazing unit as claimed in claim 12, wherein each of the two glass sheets forming the first laminated pane is at most 0.8 mm thick.

14. The insulated glazing unit as claimed in claim 6, wherein the transparent polymer material is poly (methyl methacrylate) (PMMA), polycarbonate (PC), polyurethane or polyurea (PU).
